(19) United States
(12) Patent Application Publication
(10) Pub. No.: US 2018/0122534 A1
(43) Pub. Date: May 3, 2018

(54) SUPERCONDUCTING WIRE

(71) Applicant: Sumitomo Electric Industries, Ltd., Osaka-shi, Osaka (JP)

(72) Inventors: Tatsuhiko YOSHIHARA, Osaka-shi, Osaka (JP); Tatsuoki NAGAISHI, Osaka-shi, Osaka (JP); Takashi YAMAGUCHI, Osaka-shi, Osaka (JP)

(73) Assignee: Sumitomo Electric Industries, Ltd., Osaka-shi, Osaka (JP)

(21) Appl. No.: 15/573,516

(22) PCT Filed: Feb. 24, 2016
(86) PCT No.: PCT/JP2016/055343

§ 371 Date: Nov. 13, 2017

(30) Foreign Application Priority Data
May 15, 2015 (JP) 2015-100166

(51) Int. Cl. H01B 12/06; C01G 3/00

(52) U.S. Cl. CPC H01B 12/06; C01G 3/006; H01F 6/06; C01P 2002/50; C01P 2006/40

(57) ABSTRACT

A superconducting wire includes: a laminated structure including a substrate having a main surface and a superconducting material layer formed on the main surface; and a reinforcing layer disposed on both side surfaces of the laminated structure in the width direction of the substrate. The reinforcing layer has an exposed end surface positioned on at least one side of the bottom surface and the top surface of the laminated structure. In a cross section in the width direction of the substrate, the ratio of the total width of the reinforcing layer to the width of the laminated structure is 1% or more and 15% or less.

### TECHNICAL FIELD

The present invention relates to a superconducting wire, and more particularly to a superconducting wire having a superconducting material layer formed on a substrate.

### BACKGROUND ART

Superconducting wires having a superconducting material layer on a metal substrate have recently been developed. Among those, an oxide superconducting wire has drawn attention, which includes a superconducting material layer made of an oxide superconductor which is a high-temperature superconductor having a transition temperature equal to or higher than liquid nitrogen.

Such an oxide superconducting wire is generally manufactured by forming a superconducting material layer on a metal substrate and further forming a metal layer of silver (Ag) or copper (Cu) (for example, see WO2001/008234 (PTD 1) and Japanese Patent Laying Open No. 2012-84478 (PTD 2)).

### CITATION LIST

Patent Document

### PTD 1: WO2001/008234

### PTD 2: Japanese Patent Laying Open No. 2012-84478

### SUMMARY OF INVENTION

### Technical Problem

When an oxide superconducting wire having a configuration described above is wound in the form of a coil and cooled to critical temperature, tensile stress acts on the superconducting material layer in the radial direction of the coil due to the difference in coefficient of thermal expansion between the metal layer and the superconducting material layer to cause local separation in the superconducting material layer. Thus, breakage or deformation easily occurs in part of the superconducting material layer, resulting in degradation of superconducting properties.

As measures against separation of a superconducting material layer, for example, the entire outer periphery of the superconducting wire may be covered with a thick metal tape. In the configuration above, however, the thickness of the metal tape increases the cross-sectional area of the entire superconducting wire and thus reduces the critical current density (Jc).

The present invention is made in order to solve the problem as described above, and an object of the present invention is to provide a superconducting wire in which separation of the superconducting wire can be suppressed without reducing the critical current density of the superconducting wire.

### Solution to Problem

A superconducting wire according to an aspect of the present invention includes: a laminated structure including a substrate having a main surface and a superconducting material layer formed on the main surface; and a reinforcing layer disposed on both side surfaces of the laminated structure in a width direction of the substrate. The laminated structure has a bottom surface on which the substrate is positioned, and a top surface on an opposite side to the bottom surface. The reinforcing layer has an exposed surface on at least one side of the bottom surface and the top surface of the laminated structure. In a cross section in the width direction of the substrate, a ratio of a total width of the reinforcing layer to a width of the laminated structure is 1% or more and 15% or less.

### Advantageous Effects of Invention

According to the above, separation of the superconducting wire can be suppressed without reducing the critical current density of the superconducting wire.

### BRIEF DESCRIPTION OF DRAWINGS

FIG. 1 is a cross-sectional diagram showing a configuration of a superconducting wire according to a first embodiment.

FIG. 2 is a cross-sectional diagram showing a configuration of a superconducting wire according to Example.

FIG. 3 is a cross-sectional diagram showing a configuration of a superconducting wire according to Comparative Example 1.

FIG. 4 is a cross-sectional diagram showing a configuration of a superconducting wire according to Comparative Example 2.

FIG. 5 is a schematic diagram for explaining tensile stress acting on the superconducting wire.

FIG. 6 is a cross-sectional diagram showing a configuration of a superconducting wire according to a second embodiment.

FIG. 7 is a flowchart showing a method of manufacturing a superconducting wire according to the second embodiment.

FIG. 8 is a cross-sectional diagram for explaining the method of manufacturing a superconducting wire according to the second embodiment.

FIG. 9 is a cross-sectional diagram for explaining the method of manufacturing a superconducting wire according to the second embodiment.

FIG. 10 is a cross-sectional diagram for explaining the method of manufacturing a superconducting wire according to the second embodiment.

FIG. 11 is a cross-sectional diagram for explaining the method of manufacturing a superconducting wire according to the second embodiment.

FIG. 12 is a cross-sectional diagram showing a configuration of a superconducting wire according to a modification to the second embodiment.

FIG. 13 is a cross-sectional diagram showing a configuration of a superconducting wire according to a third embodiment.

FIG. 14 is a flowchart showing a method of manufacturing a superconducting wire according to the third embodiment.

FIG. 15 is a cross-sectional diagram showing a configuration of a superconducting wire according to a modification to the third embodiment.

FIG. 16 is a cross-sectional diagram showing a configuration of a superconducting wire according to a fourth embodiment.

FIG. 17 is a flowchart showing a method of manufacturing a superconducting wire according to the fourth embodiment.

FIG. 18 is a cross-sectional view schematically showing a state in which a mask layer is formed in the fourth embodiment.

FIG. 19 is a cross-sectional diagram showing a configuration of a superconducting wire according to a fifth embodiment.

FIG. 20 is a flowchart showing a method of manufacturing a superconducting wire according to the fifth embodiment.

FIG. 21 is a schematic diagram for explaining a method of manufacturing a superconducting wire according to the fifth embodiment.

### DESCRIPTION OF EMBODIMENTS

### Description of Embodiments of the Present Invention

First of all, embodiments of the present invention will be described one by one.

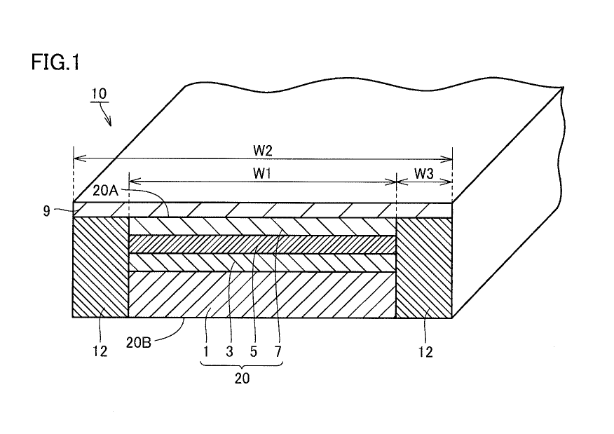

(1) A superconducting wire 10 (see FIG. 1) according to an aspect of the present invention includes a laminated structure 20 and a reinforcing layer 12. Laminated structure 20 includes a substrate 1 having a main surface and a superconducting material layer 5 formed on the main surface. Reinforcing layer 12 is disposed on both side surfaces of laminated structure 20 in a width direction of substrate 1. Laminated structure 20 has a bottom surface 20B on which substrate 1 is positioned and a top surface 20A on the opposite side to bottom surface 20B. Reinforcing layer 12 has an exposed surface on at least one side of bottom surface 20B and top surface 20A of laminated structure 20. In a cross section in the width direction of substrate 1, the ratio of the total width of reinforcing layer 12 to the width of laminated structure 20 is 1% or more and 15% or less.

In this manner, the tensile stress acting on laminated structure 20 can be distributed to reinforcing layer 12 disposed on both side surfaces of laminated structure 20, thereby improving tensile strength of superconducting wire 10. Accordingly, when superconducting wire 10 is wound in the form of a coil and cooled to extremely low temperature equal to or lower than the critical temperature, occurrence of local separation in laminated structure 20 can be suppressed. This eliminates the need for a thick metal tape covering the outer peripheral surface of laminated structure 20, thereby suppressing increase in cross section of the superconducting wire for improvement of tensile strength. As a result, occurrence of separation in the superconducting wire can be suppressed without reducing the critical current density.

In a cross section in the width direction of substrate 1, the ratio of the total width of reinforcing layer 12 to the width of laminated structure 20 is 1% or more and 15% or less, preferably 3% or more and 15% or less, more preferably 5% or more and 12% or less.

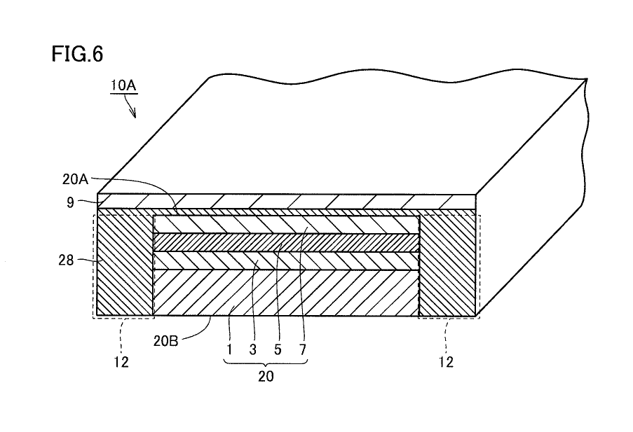

(2) A superconducting wire 10A (see FIG. 6) according to (1) above preferably further includes a coating layer 9 disposed on at least one side of top surface 20A and bottom surface 20B of laminated structure 20. In a cross section in the width direction of substrate 1, the width of coating layer 9 is wider than the width of laminated structure 20. Reinforcing layer 12 is a conductive bonding member 28 that bonds laminated structure 20 and coating layer 9 together.

In this manner, since bonding member 28 functions as reinforcing layer 12, occurrence of separation in the superconducting wire can be suppressed even in a configuration in which coating layer 9 is disposed on one side of the top surface and the bottom surface of laminated structure 20.

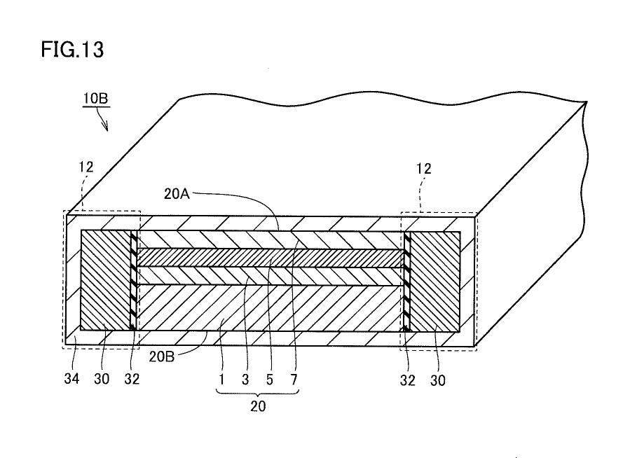

(3) In a superconducting wire 10B (see FIG. 13) according to (1) above, preferably, reinforcing layer 12 includes a metal member 30 bonded to both side surfaces of laminated structure 20 and a coating layer 34 covering the outer peripheral surface of laminated structure 20 and metal member 30.

In this manner, since metal member 30 functions as reinforcing layer 12, occurrence of separation in superconducting wire 10B can be suppressed even in a configuration in which thin-film coating layer 34 is disposed.

(4) In superconducting wire 10B according to (3) above, preferably, reinforcing layer 12 further includes a bonding layer 32 that bonds metal member 30 extending along the direction in which laminated structure 20 extends to both side surfaces of laminated structure 20.

In this manner, since metal member 30 and bonding layer 32 function as reinforcing layer 12, occurrence of separation in superconducting wire 10B can be suppressed.

(5) In superconducting wire 10B according to (3) or (4) above, preferably, coating layer 34 is formed of a foil or a plating layer of a metal material provided so as to cover the outer peripheral surface of laminated structure 20 and metal member 30.

In this manner, since coating layer 34 can be formed as a thin film, occurrence of separation in superconducting wire 10B can be suppressed without reducing the critical current density.

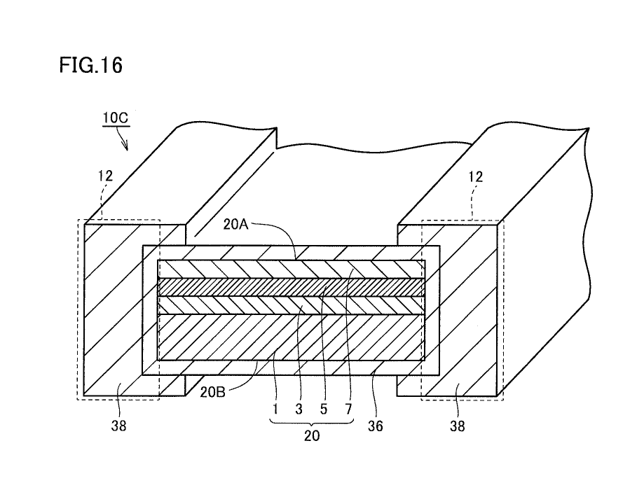

(6) In a superconducting wire 10C (see FIG. 16) according to (1) above, preferably, reinforcing layer 12 is a metal layer 38 further including an extension portion extending from on both side surfaces of laminated structure 20 onto part of bottom surface 20B and top surface 20A.

In this manner, since metal layer 38 functions as reinforcing layer 12, occurrence of separation in superconducting wire 10C can be suppressed.

(7) Superconducting wire 10C according to (6) above preferably further includes a coating layer 36 covering top surface 20A and bottom surface 20B of laminated structure 20. Metal layer 38 is formed integrally with coating layer 36.

In this manner, since metal layer 38 and coating layer 36 function as reinforcing layer 12, occurrence of separation in superconducting wire 10C can be suppressed.

(8) In superconducting wire 10C according to (7) above, preferably, metal layer 38 and coating layer 36 are formed of a plating layer.

In this manner, since coating layer 36 can be formed as a thin film while metal layer 38 has a thickness required as reinforcing layer 12, occurrence of separation in superconducting wire 10C can be suppressed without reducing the critical current density.

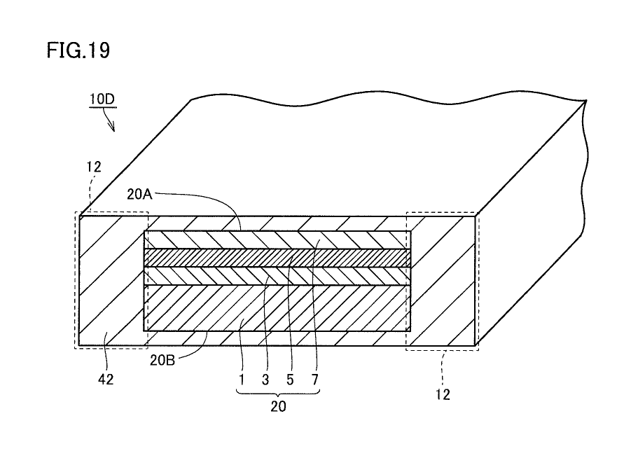

(9) A superconducting wire 10D (see FIG. 19) according to (1) above preferably further includes a coating layer 42 covering top surface 20A and bottom surface 20B of laminated structure 20. Reinforcing layer 12 is formed integrally with coating layer 42.

In this manner, since coating layer 42 positioned on both side surfaces of laminated structure 20 functions as reinforcing layer 12, occurrence of separation in superconducting wire 10D can be suppressed.

(10) In superconducting wire 10D according to (9) above, preferably, coating layer 42 is formed of a solder layer.

In this manner, since coating layer 42 positioned on the top surface and the bottom surface of laminated structure 20 can be formed as a thin film while coating layer 42 positioned on both side surfaces of laminated structure 20 has a thickness required as reinforcing layer 12, occurrence of separation in superconducting wire 10D can be suppressed without reducing the critical current density.

### DETAILS OF EMBODIMENTS OF THE PRESENT INVENTION

Embodiments of the present invention will be described below with reference to the drawings. In the description of the drawings below, the same or corresponding parts will be denoted by the same reference signs and a description thereof will not be repeated.

### First Embodiment

In a first embodiment, a basic configuration of a superconducting wire 10 according to an embodiment of the present invention will be described, and thereafter in second to fourth embodiments, a specific configuration of superconducting wire 10 and a method of manufacturing the same will be described.

(Basic Configuration of Superconducting Wire)

FIG. 1 is a cross-sectional diagram showing a configuration of a superconducting wire according to the first embodiment. FIG. 1 shows a cross section taken in the direction crossing the direction in which superconducting wire 10 according to the first embodiment extends. Therefore, the direction crossing the drawing sheet is the longitudinal direction of the superconducting wire, and it is assumed that superconducting current of superconducting material layer 5 flows along the direction crossing the drawing sheet. In the cross-sectional diagrams in FIG. 1 and subsequent drawings, although the difference in length between the top-bottom direction (hereinafter also referred to as “thickness direction”) and the left-right direction (hereinafter also referred to as “width direction”) in a rectangular cross section is reduced for the sake of clarity of the drawings, in actuality, the length in thickness direction of the cross section is sufficiently smaller than the length in the width direction.

As shown in FIG. 1, superconducting wire 10 according to the first embodiment has an elongated shape (tape-like shape) rectangular in cross section, and here a relatively large surface extending in the longitudinal direction of the elongated shape is the main surface. Superconducting wire 10 includes a substrate 1, an intermediate layer 3, a superconducting material layer 5, a protection layer 7, a coating layer 9, and a reinforcing layer 12.

Substrate 1 has a first main surface and a second main surface. The second main surface is positioned on the opposite side to the first main surface. It is preferable that substrate 1 is made of, for example, metal and formed in an elongated shape (tape-like shape) rectangular in cross section. In order to be wound into a coil, substrate 1 is preferably elongated, for example, to about 2 km.

It is further preferable that a textured metal substrate is used as substrate 1. The textured metal substrate means a substrate in which the crystal orientation is aligned with respect to two axis directions in a plane of the substrate surface. As a textured metal substrate, for example, an alloy made of two or more metals selected from nickel (Ni), copper (Cu), chromium (Cr), manganese (Mn), cobalt (Co), iron (Fe), palladium (Pd), silver (Ag), and gold (Au) is preferably used. These metals may be laminated on another metal or alloy, and, for example, an alloy such as SUS which is high-strength material can also be used. The material of substrate 1 is not limited to the above and, for example, a material other than metal may be used.

The length in the width direction of superconducting wire 10 is, for example, about 4 mm to 10 mm. In order to increase the density of current flowing through superconducting wire 10, a smaller cross-sectional area of substrate 1 is preferable. It is noted that if the thickness of substrate 1 (the top-bottom direction in FIG. 1) is too thin, the strength of substrate 1 may be degraded. Accordingly, it is preferable that the thickness of substrate 1 is, for example, about 100 μm.

Intermediate layer 3 is formed on the first main surface of substrate 1. Superconducting material layer 5 is formed on the main surface (the upper main surface in FIG. 1) of intermediate layer 3 on the opposite side to the main surface opposed to substrate 1. That is, superconducting material layer 5 is formed on the first main surface of substrate 1 with intermediate layer 3 interposed. The material that forms intermediate layer 3 is preferably, for example, yttria-stabilized zirconia (YSZ), ceric oxide (CeO₂), magnesium oxide (MgO), yttrium oxide (Y₂O₃), and strontium titanate (SrTiO₃). These materials have extremely low reactiveness with superconducting material layer 5 and do not reduce the superconducting properties of superconducting material layer 5 even at the boundary surface in contact with superconducting material layer 5. In particular, when metal is used as a material that forms substrate 1, intermediate layer 3 serves the function of alleviating the difference in orientation between substrate 1 having crystal orientation in its surface and superconducting material layer 5 and, when superconducting material layer 5 is formed at high temperature, preventing metal atoms from flowing from substrate 1 to superconducting material layer 5. The material that forms intermediate layer 3 is not limited to the above.

Intermediate layer 3 may be formed with a plurality of layers. When intermediate layer 3 is formed with a plurality of layers, the layers included in intermediate layer 3 may be formed of materials different from each other or partially the same material.

Superconducting material layer 5 is a thin-film layer to allow superconducting current to flow therethrough in superconducting wire 10. The superconducting material is preferably, but not limited to, for example, RE-123-based oxide superconductor. The RE-123-based oxide superconductor means a superconductor represented as REBa₂Cu₃O (y is 6 to 8, more preferably 6.8 to 7, RE means yttrium or a rare-earth element such as Gd, Sm, Ho). In order to improve the value of superconducting current flowing through superconducting material layer 5, the thickness of superconducting material layer 5 is preferably 0.5 μm to 10 μm.

Protection layer 7 is formed on the main surface (the upper main surface in FIG. 1) of superconducting material layer 5 on the opposite side to the main surface opposed to intermediate layer 3. Protection layer 7 is made of, for example, silver or silver alloy. The thickness of protection layer 7 is preferably 0.1 μm or more and 50 μm or less.

Laminated structure 20 is formed with substrate 1, intermediate layer 3, superconducting material layer 5, and protection layer 7 as described above. Laminated structure 20 has a bottom surface 20B on which substrate 1 is positioned and a top surface 20A on the opposite side to bottom surface 20B. Coating layer 9 is formed on top surface 20A of this laminated structure 20. Coating layer 9 may be formed on bottom surface 20B of laminated structure 20 in place of top surface 20A or in addition to top surface 20A. In a cross section in the width direction of substrate 1, it is preferable that width W2 of coating layer 9 is equal to width W1 of laminated structure 20 or wider than width W1 of laminated structure 20 (W2≥W1).

Coating layer 9 is formed of a foil or a plating layer of a metal material with good conductivity. Coating layer 9 functions together with protection layer 7 as a bypass through which current of superconducting material layer 5 is commutated when superconducting material layer 5 changes from a superconducting state to a normal conducting state. The material that forms coating layer 9 is preferably, for example, copper or copper alloy, or solder. The thickness of coating layer 9 is preferably about 20 μm to 100 μm in terms of reducing the cross-sectional area of superconducting wire 10 while physically protecting protection layer 7 and superconducting material layer 5.

Reinforcing layer 12 is disposed on both side surfaces of laminated structure 20 in the width direction of substrate 1. Reinforcing layer 12 is made of a metal material with good conductivity. The material that forms reinforcing layer 12 is preferably, for example, copper or copper alloy, nickel or nickel alloy, or solder.

In superconducting wire 10 shown in FIG. 1, width W2 of coating layer 9 is wider than width W1 of laminated structure 20 (W2>W1). Thus, both end portions in the width direction of coating layer 9 protrude from both side surfaces of laminated structure 20. Reinforcing layer 12 is provided so as to connect with both side surfaces of laminated structure 20 and the protruding portions of coating layer 9. Accordingly, the total width W3 of reinforcing layer 12 corresponds to the difference between width W2 of coating layer 9 and width W1 of laminated structure 20 (W3×2=W2−W1).

Reinforcing layer 12 has an exposed surface on at least one side of top surface 20A and bottom surface 20B of laminated structure 20. In superconducting wire 10 shown in FIG. 1, coating layer 9 wider than laminated structure 20 is disposed on top surface 20A of laminated structure 20, whereby a surface on the bottom surface side of laminated structure 20 is exposed. Though not shown, when width W2 of coating layer 9 is equal to width W1 of laminated structure 20 (W1=W2), both surfaces of reinforcing layer 12 are exposed.

In a cross section in the width direction of substrate 1, the ratio of the total width W3 of reinforcing layer 12 to width W1 of laminated structure 20 (W3×2/W1) is preferably 1% or more and 15% or less. The ratio can be more preferably 3% or more and 15% or less, further preferably 5% or more and 12% or less.

In this way, in superconducting wire 10 according to the present embodiment, reinforcing layer 12 is disposed on both side surfaces of laminated structure 20. Thus, when superconducting wire 10 is wound in the form of a coil and cooled to extremely low temperature equal to or lower than the critical temperature, occurrence of local separation in laminated structure 20 can be suppressed without reducing the critical current density (Jc) of superconducting wire 10.

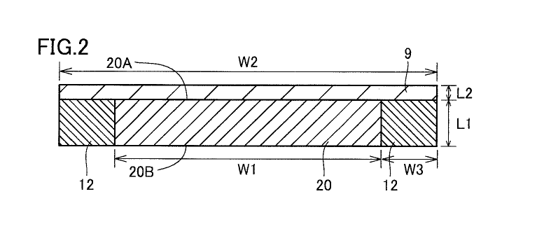

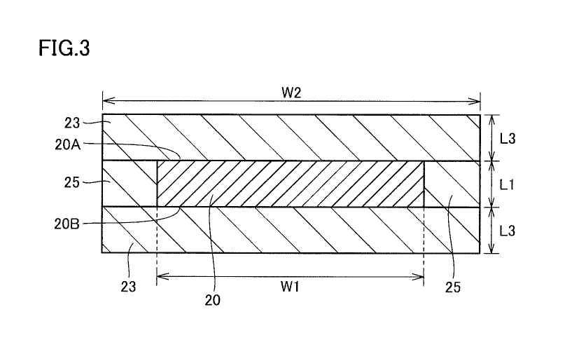

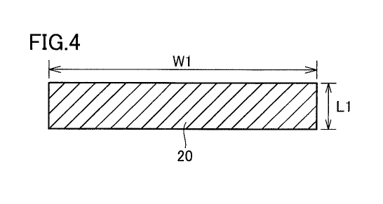

In the following, referring to Example shown in FIG. 2 and Comparative Examples shown in FIG. 3 and FIG. 4, the operation effects of superconducting wire 10 according to the present embodiment will be described. It is noted that the superconducting wire according to the present embodiment is not limited by these examples.

### Example

FIG. 2 is a cross-sectional diagram showing a configuration of a superconducting wire according to Example. FIG. 2 shows a cross section of the superconducting wire taken in the width direction.

As shown in FIG. 2, a superconducting wire including laminated structure 20, reinforcing layer 12, and coating layer 9 was prepared as Example. In the superconducting wire according to Example, laminated structure 20 has a width of 4 mm (W1=4 m) and a thickness of 100 μm (L1=100 μmm). Reinforcing layer 12 is made of copper and has a width of 0.2 mm (W3=0.2 mm) and a thickness equal to the thickness of laminated structure 20. Coating layer 9 has a width of 4.4 mm (W2=4.4 mm) and a thickness of 30 μm (L2=30 μm). That is, in Example, the ratio of the total width W3 of reinforcing layer 12 to width W1 of laminated structure 20 is 10% (W3×2/W1=10%).

### Comparative Example 1

FIG. 3 is a cross-sectional diagram showing a configuration of a superconducting wire according to Comparative Example 1. As shown in FIG. 3, a conventional 3ply structure superconducting wire was prepared as Comparative Example 1. The 3ply structure is, for example as shown in PTD 1, formed by laminating metal tapes wider than a superconducting tape on the top surface and the bottom surface of the superconducting tape and then integrating the superconducting tape and the metal tapes.

In Comparative Example 1, laminated structure 20 has a structure similar to laminated structure 20 in Example. The outer peripheral surface of laminated structure 20 is covered with metal tapes 23, 25. Metal tape 23 is disposed on each of the top surface side and the bottom surface side of laminated structure 20. Width W2 of metal tape 23 is larger than width W1 of laminated structure 20, and both end portions of metal tape 23 protrude from both side surfaces of laminated structure 20. Metal tape 25 is disposed between the protruding portions of metal tape 23. Metal tape 23 has a width of 4.4 mm (W2=4.4 mm) and a thickness of 200 μm (L3=200 μm).

That is, metal tape 25 in Comparative Example 1 has the same shape as reinforcing layer 12 in Example. On the other hand, in Comparative Example 1, metal tape 23 is disposed on each of the top surface and the bottom surface of laminated structure 20 whereby the thickness of the superconducting wire is increased compared with Example.

### Comparative Example 2

FIG. 4 is a cross-sectional diagram showing a configuration of a superconducting wire according to Comparative Example 2. As shown in FIG. 4, laminated structure 20 having a structure similar to Example was prepared as Comparative Example 2. That is, in Comparative Example 2, the outer peripheral surface of laminated structure 20 is not covered.

For each of Example and Comparative Examples 1 and 2, the tensile strength and the critical current density of the superconducting wire were evaluated by simulation. The simulation result of each superconducting wire is shown in Table 1.

TABLE 1

| | Thickness of | Tensile | Critical current |
|---|---|---|---|
| | superconducting wire | strength | density |
| | (mm) | (MA) | (A/mm²) |
| Example | 0.2 | 22 | 480 |
| Comparative | 0.5 | 22 | 90 |
| Example 1 | | | |
| Comparative | 0.1 | 10 | 500 |
| Example 2 | | | |

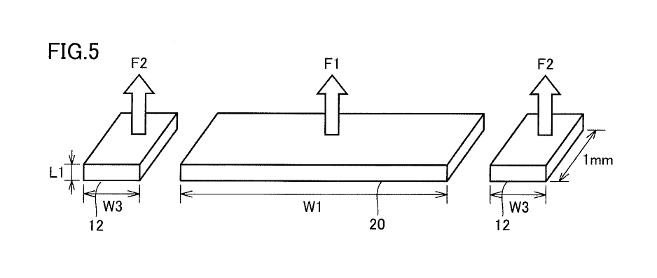

As shown in FIG. 5, when the superconducting wire wound in the form of a coil is cooled to very low temperature, in laminated structure 20, tensile stress F1 acts on the top surface and the bottom surface of laminated structure 20 due to the difference in coefficient of thermal expansion between the metal material that forms substrate 1 and protection layer 7 and the ceramic material that forms intermediate layer 3 and superconducting material layer 5. Laminated structure 20 has a tensile strength of, for example, about 1 Mpa (1 N/mm²).

When tensile stress F1 acts on laminated structure 20, tensile stress F2 also acts on reinforcing layer 12 disposed on both side surfaces of laminated structure 20. Reinforcing layer 12 is made of a metal material and therefore has a tensile strength higher than the tensile strength of laminated structure 20. For example, when reinforcing layer 12 is made of copper, reinforcing layer 12 has a tensile strength of about 220 MPa.

In Example, the tensile strength of the superconducting wire was calculated by summing the tensile strength of laminated structure 20 and the tensile strength of reinforcing layer 12 by the area ratio between laminated structure 20 and reinforcing layer 12 in the main surface of the superconducting wire. Similarly, the tensile strength of the superconducting wire according to Comparative Example 1 was calculated by summing the tensile strength of laminated structure 20 and the tensile strength of metal tape 25 by the area ratio between laminated structure 20 and metal tape 25 in the main surface of the superconducting wire. When metal tape 25 is made of copper, metal tape 25 has a tensile stress of about 220 MPa.

Furthermore, the critical current density of each superconducting wire was calculated by setting critical current Ic flowing through laminated structure 20 to 200A and dividing the set critical current Ic by the cross-sectional area of each superconducting wire.

Referring to Table 1, Example has a high tensile strength when compared with Comparative Example 2 that does not have reinforcing layer 12. This is because in Example, reinforcing layer 12 having a tensile strength higher than laminated structure 20 is disposed on both side surfaces of laminated structure 20 whereby reinforcing layer 12 takes charge of most of the tensile stress exerted on laminated structure 20 and consequently, tensile stress can be distributed to reinforcing layer 12. Also in Comparative Example 1, the tensile stress exerted on laminated structure 20 is distributed to metal tape 25 disposed on the side surfaces of laminated structure 20 in the same manner as in Example and, therefore, the tensile strength equivalent to Example is achieved.

On the other hand, the critical current density of the superconducting wire is highest in Comparative Example 2 and is lower in the order of Example and Comparative Example 1. In Example, the thickness of the metal layer provided on the top surface and bottom surface sides of laminated structure 20 is thin compared with Comparative Example 1, so that the thickness of the superconducting wire is reduced. Therefore, Example achieves a critical current density higher than Comparative Example 1 while ensuring a tensile strength equivalent to that of Comparative Example 1.

The cross-sectional area of the superconducting wire is smaller in Example than in Comparative Example 1. Thus, when the superconducting wire is wound to form a coil, the diameter of the coil is smaller in Example than in Comparative Example 1 even with equal turns. If the diameter of the coil is the same, there are more turns of the superconducting wire in Example than in Comparative Example 1.

As described above, in superconducting wire 10 according to the present embodiment, when the superconducting wire is wound in the form of a coil and cooled to very low temperature equal to or lower than the critical temperature, occurrence of separation in laminated structure 20 can be suppressed without reducing the critical current density.

In superconducting wire 10 according to the present embodiment, it is preferable that the ratio of the total width W3 of reinforcing layer 12 to width W1 of laminated structure 20 (W3×2/W1) is 1% or more and 15% or less in a cross section in the width direction of substrate 1. The ratio can be more preferably 3% or more and 15% or less, further preferably 5% or more and 12% or less.

### Second Embodiment

In the second to fifth embodiments, a specific configuration for implementing superconducting wire 10 according to the first embodiment (see FIG. 1) and a method of manufacturing the same will be described.

(Configuration of Superconducting Wire)

FIG. 6 is a cross-sectional diagram showing a configuration of a superconducting wire 10A according to the second embodiment. FIG. 6 shows a cross section of superconducting wire 10A taken in the width direction.

As shown in FIG. 6, superconducting wire 10A includes a laminated structure 20, a coating layer 9, and a bonding member 28. Coating layer 9 is disposed on a top surface 20A of laminated structure 20. The width of coating layer 9 is wider than the width of laminated structure 20.

Laminated structure 20 and coating layer 9 are bonded together by a conductive bonding member 28. As the material of bonding member 28, for example, solder is used. As shown in FIG. 6, bonding member 28 extends from between coating layer 9 and top surface 20A of laminated structure 20 onto the side surfaces of laminated structure 20.

In superconducting wire 10A, bonding member 28 positioned on the side surfaces of laminated structure 20 forms reinforcing layer 12 in superconducting wire 10 shown in FIG. 1. Reinforcing layer 12 has an exposed surface on the bottom surface side of laminated structure 20.

With the configuration described above, in the second embodiment, when superconducting wire 10A wound in the form of a coil is cooled to very low temperature, tensile stress acting on laminated structure 20 can be distributed to bonding member 28 positioned on both side surfaces of laminated structure 20. Thus, occurrence of separation in laminated structure 20 can be suppressed. Since the thin-film coating layer 9 is disposed only on top surface 20A of laminated structure 20, increase in cross-section of the superconducting wire for improvement of tensile strength can be suppressed. As a result, occurrence of separation in superconducting wire 10A can be suppressed without reducing the critical current density.

(Method of Manufacturing Superconducting Wire)

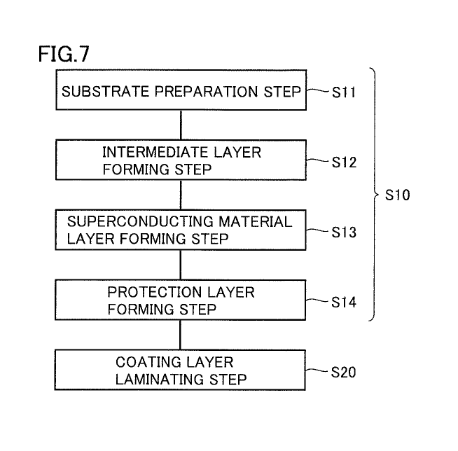

FIG. 7 is a flowchart showing a method of manufacturing superconducting wire 10A according to the second embodiment. As shown in FIG. 7, the method of manufacturing superconducting wire 10A includes a laminated structure forming step (S10) and a coating layer laminating step (S20).

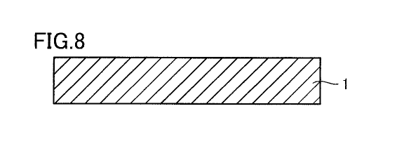

In the laminated structure forming step (S10), first of all, a substrate preparation step (S11) is performed. Specifically, referring to FIG. 8, substrate 1 formed of a textured metal substrate is prepared. Substrate 1 has a first main surface and a second main surface positioned on the opposite side to the first main surface. The thickness of substrate 1 can be adjusted as appropriate depending on the purpose and is typically set in a range of 10 μm to 500 μm.

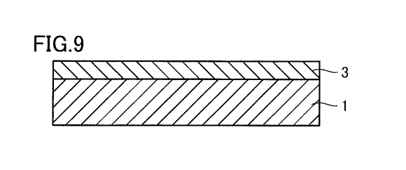

Next, an intermediate layer forming step (S12 in FIG. 7) is performed. Specifically, referring to FIG. 9, intermediate layer 3 is formed on the first main surface of substrate 1. As a deposition process for intermediate layer 3, any deposition process can be used. For example, a physical vapor deposition process such as pulsed laser deposition (PLD) can be used.

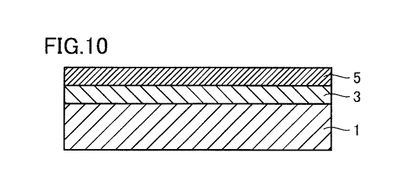

Next, a superconducting material layer forming step (S13 in FIG. 7) is performed. Specifically, referring to FIG. 10, superconducting material layer 5 made of an RE-123-based oxide superconductor is formed on the main surface of intermediate layer 3 on the opposite side to the main surface opposed to substrate 1. As a deposition process for superconducting material layer 5, any deposition process can be used. For example, a vapor-phase process and a liquid-phase process, or a combination thereof may be used. Examples of the vapor-phase process include laser vapor deposition, sputtering, and electron beam vapor deposition.

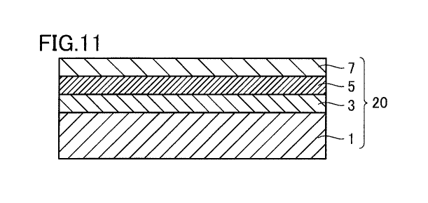

Next, a protection layer forming step (S14 in FIG. 7) is performed. Specifically, referring to FIG. 11, protection layer 7 made of silver (Ag) or silver alloy is formed on the main surface of superconducting material layer 5 on the opposite side to the main surface opposed to intermediate layer 3, for example, by physical vapor deposition such as sputtering or electroplating. Subsequently, oxygen annealing of heating under oxygen atmosphere (oxygen introducing step) is performed to introduce oxygen to superconducting material layer 5. Steps S11 to S14 above are performed to form laminated structure 20.

Next, a coating layer laminating step (S20 in FIG. 7) is performed. Specifically, first, coating layer 9 having a width wider than the width of laminated structure 20 is prepared. Coating layer 9 is a foil made of, for example, copper or copper alloy and has a thickness of, for example, 30 μm.

Next, coating layer 9 is laminated on one of top surface 20A and bottom surface 20B of laminated structure 20 using bonding member 28 such as solder. Coating layer 9 can be laminated by any method. Bonding member 28 may be melted by heating and, if necessary, pressed. For example, when coating layer 9 is laminated on top surface 20A of laminated structure 20, first, a mask layer is formed to cover bottom surface 20B of laminated structure 20. The mask layer can be formed by any method and can be applied, for example, by a coater or spraying. Next, laminated structure 20 and coating layer 9 are passed through a solder bath. Subsequently, the mask layer is removed from bottom surface 20B, and laminated structure 20 and coating layer 9 are integrally passed through between a pair of heating and pressing rollers.

Alternatively, first, bonding member 28 is formed on the main surface of coating layer 9 on the side opposed to top surface 20A of laminated structure 20. Subsequently, laminated structure 20, bonding member 28, and coating layer 9 are integrally passed through between a pair of heating and pressing rollers.

In both of the two methods above, since coating layer 9 protrudes from both side surfaces of laminated structure 20, the space between coating layer 9 and both side surfaces of laminated structure 20 is filled with solder. Reinforcing layer 12 (FIG. 1) is thus formed on both side surfaces of laminated structure 20.

(Modification to Second Embodiment)

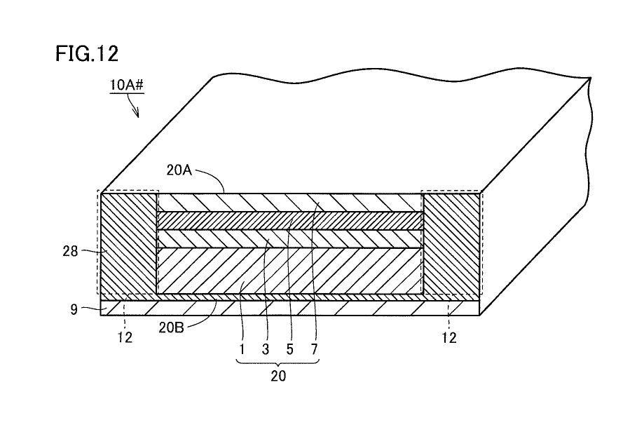

FIG. 12 is a cross-sectional diagram showing a configuration of a superconducting wire 10A# according to a modification to the second embodiment. Superconducting wire 10A# according to the modification to the second embodiment basically has a structure similar to superconducting wire 10A shown in FIG. 6 but differs from superconducting wire 10A shown in FIG. 6 in that coating layer 9 is disposed on the bottom surface side of laminated structure 20. With such a structure, the similar effect as in superconducting wire 10A shown in FIG. 6 can be achieved.

Superconducting wire 10A# according to the present modification can be manufactured by laminating coating layer 9 on bottom surface 20B of laminated structure 20 in the coating layer laminating step (S20 in FIG. 7).

### Third Embodiment

(Configuration of Superconducting Wire)

FIG. 13 is a cross-sectional diagram showing a configuration of a superconducting wire 10B according to the third embodiment. FIG. 13 shows a cross section taken in the direction crossing the direction in which superconducting wire 10B extends.

As shown in FIG. 13, superconducting wire 10B includes a laminated structure 20, a metal member 30, a bonding layer 32, and a coating layer 34. Metal member 30 has a prism-like outer shape extending in the direction in which laminated structure 20 extends. The shape of the cross section in the direction vertical to the direction in which metal member 30 extends is rectangular. The material of metal member 30 is preferably, for example, copper or copper alloy, nickel or nickel alloy, and the like.

The prism-shaped metal member 30 is bonded to both side surfaces of laminated structure 20, for example, through a conductive bonding material such as a solder bonding material or a conductive adhesive. Bonding layer 32 is formed between metal member 30 and both side surfaces of laminated structure 20.

Coating layer 34 is provided so as to cover top surface 20A and bottom surface 20B of laminated structure 20 and also cover the outer peripheral surface of metal member 30. Coating layer 34 is formed of a foil or a plating layer made of a metal material. The thickness of coating layer 34 is about 20 μm to 100μ. The metal material that forms coating layer 34 is preferably, for example, copper or copper alloy.

In superconducting wire 10B, coating layer 34 positioned on the outer peripheral surface of metal member 30, bonding layer 32, and metal member 30 forms reinforcing layer 12 in superconducting wire 10 shown in FIG. 1. Reinforcing layer 12 is configured such that the surfaces on the top surface side and the bottom surface side of laminated structure 20 are exposed.

With the configuration described above, in the third embodiment, when superconducting wire 10B wound in the form of a coil is cooled to very low temperature, tensile stress acting on laminated structure 20 can be mainly distributed to metal member 30 positioned on both side surfaces of laminated structure 20. Thus, occurrence of separation in laminated structure 20 can be reduced. Accordingly, the thickness of coating layer 34 can be reduced, so that increase in cross section of the superconducting wire for improvement of tensile strength can be suppressed. As a result, occurrence of separation in superconducting wire 10B can be suppressed without reducing critical current density Jc.

(Method of Manufacturing Superconducting Wire)

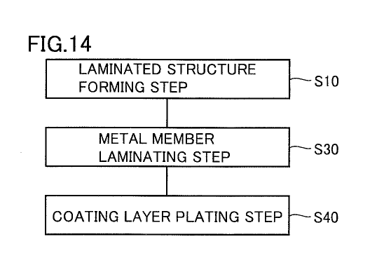

FIG. 14 is a flowchart showing a method of manufacturing superconducting wire 10B according to the third embodiment. As shown in FIG. 14, the method of manufacturing superconducting wire 10B includes a laminated structure forming step (S10), a metal member laminating step (S30), and a coating layer plating step (S40).

First of all, the laminated structure forming step (S10) shown in FIG. 7 is performed to form laminated structure 20. Next, the metal member laminating step (S20) is performed. In the metal member laminating step (S20), metal member 30 may be laminated by any method. A conductive bonding material may be melted by heated and, if necessary, pressed. For example, laminated structure 20 is passed through a solder bath, and thereafter laminated structure 20 and metal member 30 are integrally passed through between a pair of heating and pressing rollers. Alternatively, first, bonding layer 32 made of a conductive bonding member is formed on the surface of metal member 30 on the side opposed to the side surface of laminated structure 20. Subsequently, laminated structure 20 and metal member 30 are integrally passed through between a pair of heating and pressing rollers. Thus, metal member 30 is bonded to both side surfaces of laminated structure 20 with bonding layer 32 made of solder interposed.

Finally, the coating layer plating step (S40) is performed. Specifically, coating layer 34 formed of a metal layer (plating layer) is formed on the outer peripheral surface of laminated structure 20 and metal member 30. As the step of forming coating layer 34, a step of integrally covering the outer peripheral surface of laminated structure 20 and metal member 30 with a foil made of a metal material may be performed in place of the above plating step.

(Modification to Third Embodiment)

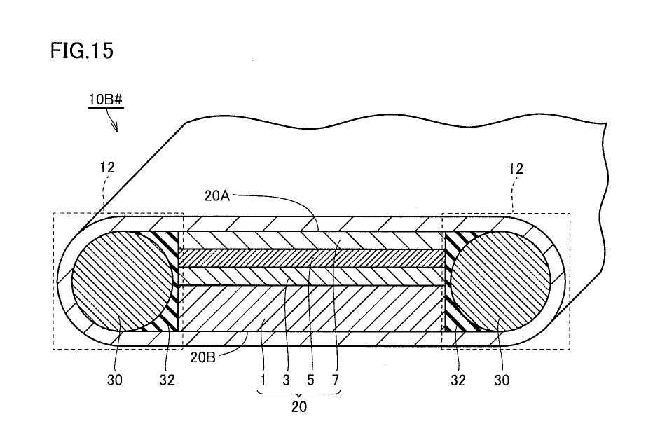

FIG. 15 is a cross-sectional diagram showing a configuration of a superconducting wire 10B# according to a modification to the third embodiment. FIG. 15 shows a cross section taken in the direction crossing the direction in which superconducting wire 10B# extends.

As shown in FIG. 15, superconducting wire 10B# according to the present modification basically has a structure similar to superconducting wire 10B shown in FIG. 13 but differs from superconducting wire 10B shown in FIG. 13 in the shape of metal member 30. In superconducting wire 10B# according to the present modification, the shape of a cross section in the direction vertical to the direction in which metal member 30 extends is circular. Thus, the side surface of superconducting wire 10B# is formed like an arc, accordingly. Also with such a configuration, the similar effect as in superconducting wire 10B shown in FIG. 13 can be achieved. The shape of a cross section in the direction vertical to the direction in which metal member 30 extends is not limited to a rectangular shape or a circular shape and may be any shapes including polygonal shapes other than a rectangular shape and an oval shape.

### Fourth Embodiment

(Configuration of Superconducting Wire)

FIG. 16 is a cross-sectional diagram showing a configuration of a superconducting wire 10C according to the fourth embodiment. FIG. 16 shows a cross section taken in the width direction of superconducting wire 10C.

As shown in FIG. 16, superconducting wire 10C includes a laminated structure 20, a coating layer 36, and a metal layer 38.

Coating layer 36 is provided so as to cover top surface 20A and bottom surface 20B of laminated structure 20 and also cover the side surfaces of laminated structure 20. Coating layer 36 is formed of a plating layer made of a metal material. The thickness of coating layer 36 is about 20 μm to 100μ. The metal material that forms coating layer 36 is preferably, for example, copper or copper alloy.

Metal layer 38 is disposed on both side surfaces of laminated structure 20. Metal layer 38 has an extension portion extending above part of bottom surface 20B and top surface 20A of laminated structure 20. That is, metal layer 38 is formed integrally with coating layer 36 that covers top surface 20A and bottom surface 20B of laminated structure 20. Metal layer 38 is formed of a plating layer made of a metal material. The material that forms metal layer 38 is preferably, for example, copper or copper alloy.

In superconducting wire 10C, coating layer 36 and metal layer 38 positioned on the side surfaces of laminated structure 20 form reinforcing layer 12 in superconducting wire 10 shown in FIG. 1. Then reinforcing layer 12 is configured such that the surfaces on the top surface side and the bottom surface side of laminated structure 20 are exposed.

With the configuration described above, in the fourth embodiment, when superconducting wire 10C wound in the form of a coil is cooled to very low temperature, tensile stress acting on laminated structure 20 can be distributed to metal layer 38 and coating layer 36 positioned on both side surfaces of laminated structure 20. Thus, occurrence of separation in laminated structure 20 can be suppressed. Furthermore, thin-film coating layer 36 is disposed on the top surface side and the bottom surface side of laminated structure 20, whereby increase in cross section of the superconducting wire for improvement of tensile strength can be suppressed. As a result, occurrence of separation in superconducting wire 10C can be suppressed without reducing the critical current density.

(Method of Manufacturing Superconducting Wire)

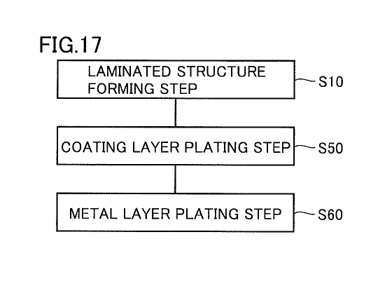

FIG. 17 is a flowchart showing a method of manufacturing superconducting wire 10C according to the fourth embodiment. As shown in FIG. 17, the method of manufacturing superconducting wire 10C includes a laminated structure forming step (S10), a coating layer plating step (S50), and a metal layer plating step (S60).

First of all, the laminated structure forming step (S10) shown in FIG. 7 is performed to form laminated structure 20. Next, the coating layer plating step (S50) is performed. Specifically, coating layer 36 formed of a metal layer (plating layer) is formed on the outer peripheral surface of laminated structure 20 by plating. In the step of forming coating layer 36, a step of integrally covering the outer peripheral surface of laminated structure 20 with a foil made of a metal material may be performed in place of the step of forming a plating layer as described above.

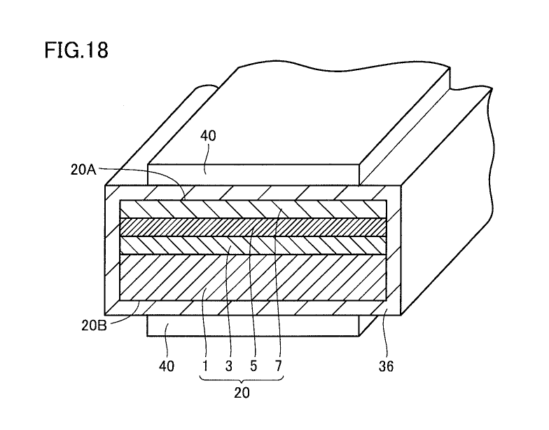

Next, the metal layer plating step (S60) is performed. Specifically, first, as shown in FIG. 18, a mask layer 40 is formed so as to cover part of coating layer 36. Mask layer 40 can be formed by any method, for example, can be applied by a coater or spraying. Mask layer 40 is disposed on each of the top surface side and the bottom surface side of laminated structure 20 and has a width narrower than the width of laminated structure 20.

Subsequently, a plating layer (metal layer 38) is formed so as to cover coating layer 36 having mask layer 40 formed thereon. The plating layer has an extension portion extending onto part of top surface 20A and bottom surface 20B of laminated structure 20. It is noted that the plating layer may not be formed on the top surface side and the bottom surface side of laminated structure 20 as long as it is formed on both side surface sides of laminated structure 20. The plating layer may be formed by any method, for example, formed by electroplating. Subsequently, mask layer 40 is removed. Mask layer 40 can be removed by any method, for example, can be removed by etching. Thus, metal layer 38 formed of a plating layer can be formed on both side surfaces of laminated structure 20.

In the flowchart in FIG. 17, although the configuration in which the metal layer plating step (S60) is performed after the coating layer plating step (S50) is performed has been described, the coating layer plating step (S50) may be performed after the metal layer plating step (S60) is performed. In this case, after a plating layer serving as metal layer 38 is formed on both side surfaces of laminated structure 20, a plating layer serving as coating layer 36 is formed so as to cover the outer peripheral surface of laminated structure 20 and metal layer 38.

### Fifth Embodiment

FIG. 19 is a cross-sectional diagram showing a configuration of a superconducting wire 10D according to the fifth embodiment. FIG. 19 shows a cross section taken in the width direction of superconducting wire 10D.

As shown in FIG. 19, superconducting wire 10D includes a laminated structure 20 and a coating layer 42.

Coating layer 42 is provided so as to cover the outer peripheral surface of laminated structure 20. Coating layer 42 is formed of a solder layer. In a cross section in the width direction of substrate 1, the thickness of coating layer 42 positioned on both side surfaces of laminated structure 20 is thicker than the thickness of coating layer 42 positioned on the top surface side and the bottom surface side of laminated structure 20.

In superconducting wire 10D, reinforcing layer 12 is formed with coating layer 42 positioned on both side surfaces of laminated structure 20. In other words, reinforcing layer 12 is formed integrally with coating layer 42.

With the configuration described above, in the fifth embodiment, when superconducting wire 10D wound in the form of a coil is cooled to very low temperature, tensile stress acting on laminated structure 20 can be distributed to coating layer 42 (solder layer) positioned on both side surfaces of laminated structure 20. Thus, occurrence of separation in laminated structure 20 can be suppressed. Furthermore, thin-film coating layer 36 is disposed on the top surface side and the bottom surface side of laminated structure 20, whereby increase in cross section of the superconducting wire for improvement of tensile strength can be increased. As a result, occurrence of separation in superconducting wire 10D can be suppressed without reducing the critical current density.

(Method of Manufacturing Superconducting Wire)

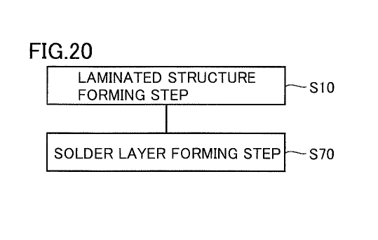

FIG. 20 is a flowchart showing a method of manufacturing superconducting wire 10D according to the fifth embodiment. As shown in FIG. 20, the method of manufacturing superconducting wire 10D includes a laminated structure forming step (S10) and a solder layer forming step (S70).

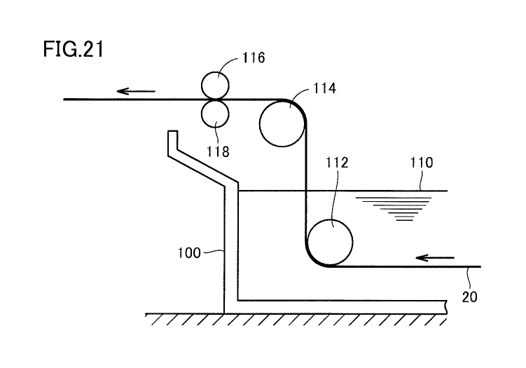

First of all, the laminated structure forming step (S10) shown in FIG. 7 is performed to form laminated structure 20. Next, the solder layer forming step (S70) is performed. In the solder layer forming step (S70), as shown in FIG. 21, the entire laminated structure 20 is passed through a solder bath 100 using rolls 112, 114 while being soaked in molten solder liquid 110 in solder bath 100. On the exit side of solder bath 100, a pair of ringer rolls 116, 118 are provided. The solder adhering to top surface 20A and bottom surface 20B of laminated structure 20 is squeezed by a pair of ringer rolls 116, 118, whereby coating layer 42 formed of a solder layer is formed. The thickness of the solder layer positioned on the top surface and the bottom surface of laminated structure 20 and the thickness of the wider layer positioned on both side surfaces of laminated structure 20 can be adjusted by, for example, the pressing condition in a pair of ringer rolls 116, 118 and the speed at which laminated structure 20 is conveyed.

It is understood that the embodiments and examples disclosed herein is illustrative in all respects and not limitative. The scope of the present invention is shown not by the foregoing embodiments and examples but by the clams, and it is intended that all equivalents to the claims and modifications within the scope of the claims are embraced.

### REFERENCE SIGNS LIST

1 substrate, 3 intermediate layer, 5 superconducting material layer, 7 protection layer, 9, 34, 36 coating layer, 10, 10A to 10D superconducting wire, 12 reinforcing layer, 20 laminated structure, 30 metal member, 32 bonding layer, 38 metal layer, 40 mask layer, 100 solder bath, 110 solder liquid, 112, 114 roll, 116, 118 ringer roll

1: A superconducting wire comprising:
a laminated structure including a substrate having a main surface and a superconducting material layer formed on the main surface; and
a reinforcing layer disposed on both side surfaces of the laminated structure in a width direction of the substrate,
the laminated structure having a bottom surface on which the substrate is positioned, and a top surface on an opposite side to the bottom surface,
the reinforcing layer having a surface on at least one side of the bottom surface and the top surface of the laminated structure, the surface being exposed, and
in a cross section in the width direction of the substrate, a ratio of a total width of the reinforcing layer to a width of the laminated structure being 1% or more and 15% or less.

2: The superconducting wire according to claim 1, further comprising a coating layer disposed on at least one side of the top surface and the bottom surface of the laminated structure, wherein
in a cross section in the width direction of the substrate, a width of the coating layer is wider than a width of the laminated structure, and
the reinforcing layer is a conductive bonding member bonding the laminated structure and the coating layer together.

3: The superconducting wire according to claim 1, wherein
the reinforcing layer includes:
a metal member bonded to both side surfaces of the laminated structure; and
a coating layer covering an outer peripheral surface of the laminated structure and the metal member.

4: The superconducting wire according to claim 3, wherein the reinforcing layer further includes a bonding layer bonding the metal member extending along a direction in which the laminated structure extends, to both side surfaces of the laminated structure.

5: The superconducting wire according to claim 3, wherein the coating layer is formed of a foil or a plating layer made of a metal material provided to cover an outer peripheral surface of the laminated structure and the metal member.

6: The superconducting wire according to claim 1, wherein the reinforcing layer is a metal layer further including an extension portion extending from on both side surfaces of the laminated structure onto part of the bottom surface and the top surface.

7: The superconducting wire according to claim 6, further comprising a coating layer covering the top surface and the bottom surface of the laminated structure,
wherein the metal layer is formed integrally with the coating layer.

8: The superconducting wire according to claim 7, wherein the metal layer and the coating layer are formed of a plating layer.

9: The superconducting wire according to claim 1, further comprising a coating layer covering the top surface and the bottom surface of the laminated structure,
wherein the reinforcing layer is formed integrally with the coating layer.

10: The superconducting wire according to claim 9, wherein the coating layer is formed of a solder layer.
